(19) United States
(12) Patent Application Publication
(10) Pub. No.: US 2016/0130488 A1
(43) Pub. Date: May 12, 2016

(54) LOW DEGREE OF SUBSTITUTION SODIUM CARBOXYMETHYLCELLULOSE FOR SOIL STABILIZER AND WATER RETARDANT FILM

(71) Applicant: Solenis Technologies, L.P., Schaffhausen (CH)

(72) Inventors: Zoha Moussa Al-Badri, West Grove, PA (US); Kurt Jonathan Beers, Claymont, DE (US); Kirill Bakeev, Newark, DE (US)

(21) Appl. No.: 14/691,153

(22) Filed: Apr. 20, 2015

Related U.S. Application Data
(60) Provisional application No. 61/972,744, filed on Mar. 31, 2014.

(51) Int. Cl. C09K 3/22; C09K 17/40; B05D 1/02; C09K 17/22; C09K 17/18; C09K 17/32; C09K 17/20

(52) U.S. Cl. CPC C09K 3/22; C09K 17/32; C09K 17/40; C09K 17/20; C09K 17/22; C09K 17/18; B05D 1/02

(57) ABSTRACT

A method of stabilizing an aggregate substrate comprising applying to the upper surface of the substrate an aqueous composition comprising carboxymethylcellulose having a low degree of substitution. The aqueous composition comprising carboxymethylcellulose will suppress dust generation, repel water, inhibit water seepage and retard erosion.

This application claims the benefit of and priority to co-pending U.S. Provisional Application Ser. No. 61/972,744, filed Mar. 31, 2014 and entitled “Low Degree of Substitution Sodium Carboxymethylcellulose For Soil Stabilizer and Water Retardant Film”, the disclosure of which is incorporated by reference herein in its entirety.

### BACKGROUND OF THE INVENTION

The invention relates to the application of low degree of substitution (“low-DS”) carboxymethyl cellulose (“CMC”) to substrates, such as aggregate substrates, to prevent and/or control the development of dust from such surfaces and to generally stabilize the aggregate material. Typically, the low-DS CMC in water is applied to the surface of a substrate and dries on the surface. Once the low-DS CMC has dried on top of the surface, it forms a durable layer that can suppress the generation of dust from the surface and the substrate, as well as repel water, inhibit water from seeping from surface into the substrate and retard erosion of the substrate.

Aggregate substrates generally comprise loosely compacted particles and thus are subject to generation of dust and erosion when exposed to external forces that are either natural, such as the action of wind and rain on the substrate, or manmade, such as the act of a vehicle traversing the surface of an aggregate substrate, like a gravel or rock road. Control and prevention of dust generation and erosion is desired. For example, aqueous mixtures of alkyl cellulose compounds and halogen containing salts can be applied to the surfaces of aggregate substrates to control dust formation from the surface of the substrate. Latex polymer type film has been used over soils to reduce dust and erosion. Cellulosic polymers in combination with fly ash to create a film barrier over the aggregate surface is another technique that has been applied for dust and erosion control. Certain hydroxyalkylmethylcellulose polymers having a particular viscosity range, biodegradable carbohydrates and cellulosic fibers have also been suggested as potential film barriers to stabilize soil and other aggregate surfaces.

Aggregate substrates come in many forms. Examples include roadways, train track beds, fields, soil piles, mineral stock piles and the like. Further examples include aggregate substances accumulated in truck beds and open train cars. Various aspects of commercial mining operations generate dust from operations and aggregate substances are routinely processed through operations by way of conveyors with the aggregate exposed to the environment thereby requiring means to prevent and/or control dust generation and erosion. Mining operations generate waste byproducts from processing mineral ore. These byproducts are generally in the form of highly concentrated metal containing aggregates that are transported to tailings ponds and disposed as tailing piles for a considerable amount of time while more tailings are delivered, until such a time when the processing of mineral ore is done and the land can be set for reclamation. It is desired to prevent the generation of dust and erosion of such tailing piles as well as maintain the structural integrity of the tailing piles.

All parts and percentages set forth herein are by weight unless otherwise specified.

### SUMMARY OF THE INVENTION

Low-DS CMC is effective in stabilizing the surface of an aggregate substrate to inhibit and/or prevent the formation of dust from the surface of the aggregate substrate and to stabilize the aggregate substrate to prevent erosion of material from the aggregate substrate. The low-DS CMC is applied in an aqueous composition to the surface of an aggregate substrate to protect the surface of the aggregate substrate from wind and water by forming a barrier/coating that repels the water and wind. The aqueous composition may further comprise one or more supplemental soil stabilizing compounds in addition to the low-DS CMC. Further, the aqueous composition comprising low-DS CMC can be applied with other compositions comprising supplemental soil stabilizing compounds.

### DESCRIPTION OF THE DRAWINGS

FIG. 1 is a graph showing the results of the tests of Examples 1-3, the loss of gold ore from specimens in test cups treated with aqueous compositions comprising low-DS CMC due to water erosion after three 100 mL washes with water.

FIG. 2 is a graph showing the results of the tests of Examples 4-9, rain test performance of CMC-45 and ASH-100 carbohydrate for gold ore specimens in test cups treated in mixed and dual applications subjected to three 100 mL washes with water.

### DETAILED DESCRIPTION OF THE INVENTION

The process for stabilizing an aggregate substrate having at least an upper surface comprises the step of applying an aqueous composition comprising low-DS CMC to the upper surface of the aggregate substrate. The aqueous composition may be a solution or a dispersion. The degree of substitution of the low-DS CMC is typically up to about 1.0, such as up to about 0.6. For example, the degree of substitution may be from about 0.33 to about 0.94, like about 0.40 to about 0.80 and including about 0.40 to about 0.60. The aqueous composition may comprise up to about 10% the CMC, such as about 1% to about 7% of low-DS CMC, like about 1% to about 5% low-DS CMC. Persons of ordinary skill in these arts, after reading this disclosure, will appreciate that all ranges and values for the degree of substitution and amount of CMC in the aqueous composition are within the scope of the invention. The aqueous composition further comprises water and may consist essentially of or consist of the low-DS CMC and water. Biocides may be included in the aqueous composition such that the aqueous composition may comprise, consist essentially of or consist of low-DS CMC, biocide and water. Further, the low DS-CMC may include impurities inherent in the product, like sodium monoglycolate and sodium diglycolate which can be present in amounts of up to about 30%.

The aggregate substrate comprises inorganic particulate material, organic particulate material or combinations thereof. The particulate material is selected from the group consisting of a mineral, ore, dust, soil, mulch, stone, trash, rubbish, and combinations thereof. Mineral ores typically comprise base metals, precious metals or combinations of these. Some examples of base metals or precious metals that may comprise the mineral ore include a metal selected from the group consisting of gold, aluminum, silver, platinum, copper, nickel, zinc, lead, molybdenum, iron, and the like, and combinations thereof. Other materials that may comprise the mineral ore include phosphate, coal, and the like, and combinations thereof.

After application to the upper surface of the aggregate substrate the aqueous composition forms a dried residue which suppresses removal of particulate material from the upper surface. Further, the dried residue of the aqueous composition prevents erosion of the particulate material from the aggregate substrate and repels water from permeating through the upper surface into the aggregate.

Supplemental soil stabilizing compounds and compositions comprising supplemental soil stabilizing compounds may be applied to the upper surface of the aggregate substrate with the aqueous composition comprising the low-DS CMC. Also, aqueous compositions comprising the low-DS CMC may further comprise supplemental soil stabilizing compounds, and also may consist essentially of or consist of low-DS CMC, soil stabilizing compounds and water and, optionally, biocide. Supplemental soil stabilizing compounds include carbohydrate, hydrolyzed starch, hydrolyzed carbohydrate, crude tall oil, fatty acid, esters of fatty acid, rosin, rosin acid, esters of rosin acid, lignosulfonate, magnesium halide, calcium halide, ammonium sulfate, synthetic polymer, such as polyacrylamide, polyacrylate, polyvinyl alcohol, polyethylene oxide, and the like. Further, the supplemental soil stabilizing compound may be any type of latex based products or latex waste products. Combinations of supplemental soil stabilizing compounds may be used. ASH-100 carbohydrate available from Ashland, Inc., Covington, Ky., U.S.A. may be used.

The method of stabilizing an aggregate substrate having at least an upper surface may comprise the step of applying an aqueous composition comprising low-DS CMC and one or more supplemental soil stabilizing compounds to the upper surface of the aggregate substrate, which can be referred to as a mixed application. Also, in a dual application, the method may further comprise the step of applying a composition comprising one or more supplemental soil stabilizing compounds, such as a those mentioned above, like carbohydrate, to the upper surface of the aggregate substrate prior to, during or after application of the aqueous composition comprising the low-DS CMC.

The composition comprising the supplemental soil stabilizing compound can comprise up to about 6% of a soil stabilizing compound, such as about 1% to about 5%, or about 1% to about 3%, soil stabilizing compound. In embodiments, the supplemental soil stabilizing compound is a carbohydrate forming a carbohydrate composition which can be applied to an aggregate substrate with the low-DS CMC. This carbohydrate composition can comprise up to about 6% carbohydrate, such as about 1% to about 5%, or about 1% to about 3% carbohydrate. One skilled in the art will appreciate that all parts and percentages for the soil stabilizing compound or carbohydrate composition within the specified ranges are within the scope of the invention.

Means for applying the aqueous composition by spraying the aqueous composition on the upper surface of an aggregate substrate can be provided in the methods discussed above. Such means may comprise a spraying unit and a means for conveying the spraying unit, like a human being and a motorized device. Motorized devices can include carts, all terrain vehicles, cars, trucks and self-propelled spraying units.

The aqueous composition comprising the low-DS CMC provides a surface barrier on the surface of the aggregate substrate that has better soil stabilizing performance than conventional dust suppression agents. As the aqueous composition is applied to the surface of an aggregate substrate, like mineral ore, the dispersible cellulose fibers bind to the ore and form a water barrier film that coats the surface of the ore. Therefore, it is important that the CMC be able to quickly and uniformly diffuse on top of and throughout the aggregate surface. The low-DS CMC applied in the form of an aqueous solution or aqueous dispersion allows for this diffusion to take place. CMC applied in this uniform manner, will allow the film coating to form uniformly as well, thus maximizing the performance.

### EXAMPLES

In the examples, aqueous compositions comprising commercially available low-DS CMC from several sources were applied to surface of aggregate substrates comprising gold ore. The degree of substitution (DS) of the low-DS CMC ranged from 0.33 to 0.94 as noted in Table 1. The physical properties of the low-DS CMC are set forth in Table 1.

TABLE 1

| | | | Viscosity | | |
|---|---|---|---|---|---|
| CMC Type | DS | % Solids | (cP) @ 25 C. | Spindle | BPM |
| CMC-94 | 0.94 | 3 | 520 | 62 | 30 |
| CMC-61 | 0.61 | 3 | 375 | 61 | 10 |
| CMC-53 | 0.53 | 3 | 100 | 61 | 50 |
| CMC-45 | 0.45 | 3 | 60 | 61 | 50 |
| CMC-33 | 0.33 | 3 | 5 | 61 | 100 |

The low DS-CMC used in the examples was industrial grade and contained some level of a sodium salt of mono and diglycolate impurities, which are the byproducts of monochloroacetic acid that is used to functionalize cellulose.

After determining the solids/moisture contents of the powdered low-DS CMC as obtained from the supplier, 10% active aqueous stock compositions (i.e., compositions comprising 10% of the respective low-DS CMC) were prepared by mixing the low-DS CMC with water. Powdered low-DS CMC was added slowly, over the course of an hour for each, into 500 mL of water per sample at ambient temperature (˜22° C./72° F.) and mixed at 750 RPM with cowles blades until completely dissolved or dispersed into water. Samples comprising CMC-94 and CMC-61 required additional mix time (one and one half hours each). Biocide was added to each composition during mixing to prevent contamination that could have had an adverse effect on viscosity (through degradation) or performance during testing.

After mixing the stock compositions, the rate of active ingredient of each was qualified using a Mettler-Toledo MJ33 Moisture Balance, available from Mettler-Toledo LLC, 1900 Polaris Parkway, Columbus, Ohio 43240. Likewise, all lower active rate compositions obtained from the 10% stock composition were qualified in the same manner to ensure accuracy of active rates in each composition for each test.

As discussed in more detail below, the aqueous compositions prepared in each example were applied to specimens comprising sieved gold dust from Lakeshore Mines in Canada prepared in test cups. Each test cup was filled with 65 grams of −100 mesh sieved gold dust. For each aqueous composition prepared in the examples below, three test cups were prepared as specimens for testing. One sample set of three specimens for each composition in each series and example was prepared and tested. After filling each specimen cup with 65 g of gold dust, a Teflon puck was used to level off the material and then the outer edge of the puck was used to create a bermed edge to avoid overflow of the applied aqueous compositions and facilitate even distribution of sample aqueous compositions.

Disposable pipettes were then used to apply the aqueous composition to the specimens in the test cups. The application procedures are discussed in more detail in each of the examples. Pipettes were used to discharge the aqueous composition onto surface of the specimens in the test cups in a circular motion to ensure uniformity of application. After application, the specimens were dried in a convection oven for 16 hours at 35° C. (95° F.). The testing cups with specimen were stored in a moisture controlled environment to ensure moisture level uniformity between specimens during testing.

In the examples, a “rain test” was applied to the specimens. Under the procedure developed for the “rain test” all specimens were tested using a custom designed sprayer set-up from Spraying Systems Co. (Wheaton, Ill., U.S.A.) with tap water delivered at 5 psi (pounds per square inch) from a one-gallon pressure pot, controlled by an electronic timer and a Skinner Valve Systems (New Britain, Conn., U.S.A.) solenoid (valve #71215, 24 VDC, 256046 orifice, code 11438-21D). A coarse, full jet tip (GGA-SS3001.4) from Spraying Systems Co. was used to attain a wide conical pattern of water spray positioned to cover the entire surface area of each specimen (dust/ore in a test cup), with the test cup positioned within a 20 degree angled, TEFLON® base to facilitate run-off of water and the cast-off dust/ore from a specimen for collection. The system was timed/calibrated to deliver 100 mL of water to each specimen as a rain simulation. The cascaded water with dust/ore was then washed off of the angled base (inside and out) and from around the outer diameter of the test cups then collected into an aluminum pan. This rain procedure was repeated three times for each sample and results were recorded to assess the potential for water repellency of the aqueous compositions described in the examples. The drying procedure discussed above was applied between each wash.

After fines were rinsed off of specimens in the test cups and the angled TEFLON base into an aluminum pan, the fines were collected from the pan onto an oven-dried, pre-weighed WHATMAN® Glass Microfibre Filter (934-AH, 100 mm diameter, catalog 1827 110) available from GE Whatman, Pittsburgh, Pa., USA by placing the filter within a ceramic funnel attached to a filter flask and vacuum pump (MD1C 1.5 m³/hr, 120V, 60 Hz available from Vaccubrand, Essex, Conn., USA). The filters were primed down with a water seal before introducing the water/fines mixture through the filter. The filtered out water was collected into a 500 mL filter flask and the fines that remained on the filter were oven dried at 100° C. for 12 hours. Once dried, each filter was weighed to determine loss per specimen (subtracting the weight of the filter from the weight of the collected fines).

Aqueous compositions comprising 1.5%, 3.0% and 5.0% low-DS CMC active rates, prepared from the 10% stock composition, (one set of each active rate in triplicate for each low-DS CMC type) were prepared for the Examples 1-3 as described below. CMC-61, CMC-53, CMC-45, and CMC-33 formed water dispersible suspension of cellulose fibers when mixed with water in each of the 1.5%, 3.0% and 5.0% composition and the water dispersible cellulose fibers settled over time upon standing. CMC-94 was completely water soluble in each of the 1.5%, 3.00% and 5.0% composition.

### Example 1

In this example, aqueous compositions comprising 1.5% low-DS CMC were made from CMC-94, CMC-61, CMC-53, CMC-45 and CMC-33 described in Table 1 and applied to specimens in the test cups as discussed above. The specimens were then subject to the rain test described above.

Fifteen grams (15 g) of 10% stock composition comprising CMC-94 was diluted with 85 g of tap water to make a final aqueous 1.5% composition comprising 1.5% CMC-94. This 1.5% composition was then applied at a rate of 2 L/nm (8.48 g composition per specimen) as a film application to three specimens in test cups containing sieved, 65 g “−100 mesh” gold ore. The specimens were dried before each of three rain tests of 100 mL tap water through spray fixture for each of the three specimens.

Fifteen grams (15 g) of 10% stock composition comprising CMC-61 was diluted with 85 g of tap water for a final aqueous 1.5% composition comprising 1.5% CMC-61. This 1.5% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

Fifteen grams (15 g) of 10% stock composition comprising CMC-53 was diluted with 85 g of tap water for a final aqueous 1.5% composition comprising 1.5% CMC-53. This 1.5% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

Fifteen grams (15 g) of 10% stock composition comprising CMC-45 was diluted with 85 g of tap water for a final aqueous 1.5% composition comprising 1.5% CMC-45. This 1.5% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

Fifteen grams (15 g) of 10% stock composition comprising CMC-33 was diluted with 85 g of tap water for a final aqueous 1.5% composition comprising 1.5% CMC-33. This 1.5% composition was then applied at a rate of 21 m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

### Example 2

In this example, aqueous compositions comprising 3.0% low-DS CMC were made from CMC-94, CMC-61, CMC-53, CMC-45 and CMC-33 described in Table 1 and applied to specimens in the test cups as discussed above. The specimens were then subject to the rain test described above.

Fifteen grams (15 g) of 10% stock composition comprising CMC-94 was diluted with 70 g of tap water to make a final aqueous 3.0% composition comprising 3.0% CMC-94. This 3.0% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

Fifteen grams (15 g) of 10% stock composition comprising CMC-61 was diluted with 70 g of tap water to make a final aqueous 3.0% composition comprising 3.0% CMC-61. This 3.0% composition was then applied at a rate of 2 L/m² (8.48 g composition per specimen) as a film application to three specimens containing sieved, 65 g “−100 mesh” gold ore. The specimens were dried before each of three rain tests of 100 mL tap water through spray fixture for each of the three specimens.

Fifteen grams (15 g) of 10% stock composition comprising CMC-53 was diluted with 70 g of tap water to make a final aqueous 3.0% composition comprising 3.0% CMC-53. This 3.0% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

Fifteen grams (15 g) of 10% stock composition comprising CMC-45 was diluted with 70 g of tap water to make a final aqueous 3.0% composition comprising 3.0% CMC-45. This 3.0% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

Fifteen grams (15 g) of 10% stock composition comprising CMC-33 was diluted with 70 g of tap water to make a final aqueous 3.0% composition comprising 3.0% CMC-33. This 3.0% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

### Example 3

In this example, aqueous compositions comprising 5.0% low-DS CMC were made from CMC-94, CMC-61, CMC-53, CMC-45 and CMC-33 described in Table 1 and applied to specimens in the test cups as discussed above. The specimens were then subject to the rain test described above.

Fifteen grams (15 g) of 10% stock composition comprising CMC-94 was diluted with 50 g of tap water to make a final aqueous 5.0% composition comprising 5.0% CMC-94. This 5.00/% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

Fifteen grams (15 g) of 10% stock composition comprising CMC-61 was diluted with 50 g of tap water to make a final aqueous 5.0% composition comprising 5.0% CMC-61. This 5.0% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

Fifteen grams (15 g) of 10% stock composition comprising CMC-53 was diluted with 50 g of tap water to make a final aqueous 5.0% composition comprising 5.0% CMC-53. This 5.0% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

Fifteen grams (15 g) of 10% stock composition comprising CMC-45 was diluted with 50 g of tap water to make a final aqueous 5.0% composition comprising 5.0% CMC-45. This 5.0% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three 3 specimens.

Fifteen grams (15 g) of 10% stock composition comprising CMC-33 was diluted with 50 g of tap water to make a final aqueous 5.0% composition comprising 5.0% CMC-33. This 5.0% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

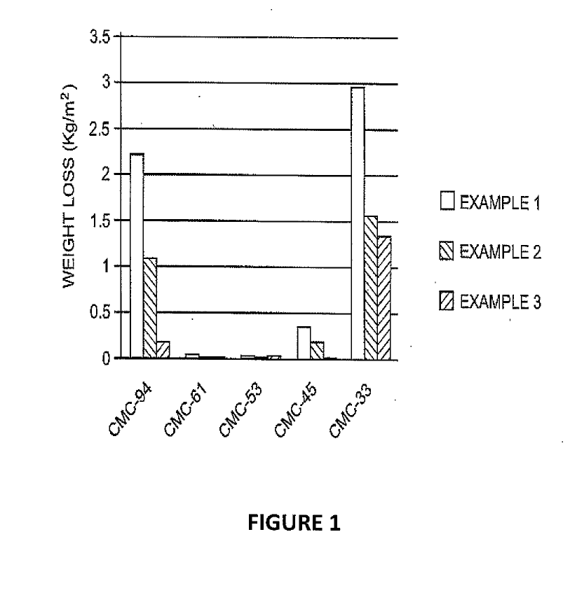

FIG. 1 shows the cumulative weight loss of the surfaces of the specimens treated with the aqueous compositions of Examples 1-3 having 1.5%, 3.0% and 5.0% low-DS CMC as set forth in Table 1 after subjected to three successive washes with 100 mL water in the rain test discussed above. The graph in FIG. 1 shows that when aqueous compositions having 1.5% low-DS CMC were applied to the specimens, the aqueous composition comprising CMC-33 resulted in the highest weight loss (2.95 Kg/m²). The weight loss was reduced by about 50% to 1.56 Kg/m² by applying the aqueous composition comprising 3.0% CMC-33 at 2 L/m². Applying the aqueous composition comprising 5.0% CMC-33 at 2 L/m² reduced the weight loss to 1.35 Kg/m². When specimens were treated with aqueous compositions comprising 1.5% CMC-94 and subjected to the rain test the result was 2.22 Kg/m² weight loss after three consecutive washes as indicated in the graph in FIG. 1. As the active solid concentration of the aqueous compositions comprising CMC-94 increased to 3.0% and 5.0%, the weight loss of the treated specimens decreased significantly. When aqueous compositions comprising 3.0% and 5.0% CMC-94 were applied at 2 L/m² the result was 1.10 kg/m² and 0.18 Kg/m² gold ore weight loss. The aqueous composition having 5% CMC-94 was difficult to apply due high viscosity and the sample took longer to diffuse into the specimen than other aqueous compositions. However, aqueous compositions comprising 1.5%, 3.0%, and 5.0% CMC-61, CMC-53, and CMC-45 show the best results as indicated in the graph of FIG. 1. The gold ore weight loss for specimens treated with aqueous compositions comprising 1.5% and 3.0% CMC-45 after three successive washes with 100 mL water in the rain test was 0.035 Kg/m² and 0.19 Kg/m², respectively. Applying an aqueous composition having 5.0% CMC-45 to the specimens having gold ore reduced the ore weight loss to about 0.019 Kg/m². The weight loss after the rain test for specimens having gold ore treated aqueous compositions with 1.5%, 3.0% and 5.0% CMC-61 and CMC-53 were very low.

Aqueous compositions comprising CMC-61, CMC-53, and CMC-45 in Examples 1-3 showed good performance by significantly reducing gold ore weight loss, however, those compositions having the low-DS with the highest and lowest degrees of substitutions, CMC-94 and CMC-33, respectively, did not perform as well. This suggests that there exists a critical DS range that falls within DS value about 0.94 and about 0.33. It is also worth mentioning that having aqueous composition comprising cellulose fibers is important for obtaining the water resistance properties that are needed to reduce ore erosion. As the low-DS CMC is applied to the ore, the cellulose fibers bind to the ore and form a water barrier film that coats the surface of the ore.

In Examples 4 to 9, the use of carbohydrate and low-DS CMC to treat the surfaces of aggregate substrates was evaluated. A carbohydrate (ASH-100) and CMC-45, as described in Table 1, were tested to assess potential synergy between the two as a dual application (carbohydrate applied to specimens at a rate of 1 L/m² followed by CMC applied at a rate of 1 L/m²) and as a mixed application (carbohydrate and CMC mixed into a single aqueous composition having 3% and 6% active content and applied to specimens at a rate of 2 L/m²).

Aqueous compositions comprising CMC-45, as described in Table 1, and ASH-100 carbohydrate were made for Examples 4-9, as described below, from 10% stock compositions comprising CMC-45 and 50% stock compositions comprising ASH-100. In making these stock compositions, powdered low-DS CMC 45 and ASH-100 were added slowly, over the course of an hour for each, into 500 mL of water per sample separately at ambient temperature (˜22° C./72° F.) and mixed at 750 RPM with cowles blades until completely dissolved or dispersed into water to make the stock compositions. Biocide was also added. After mixing the stock compositions, the rate of active ingredient of each was qualified using a Mettler-Toledo MJ33 Moisture Balance as discussed above. Likewise, all lower active rate compositions obtained from the 10% stock composition and the 50% stock composition were qualified in the same manner to ensure accuracy of active rates in each composition for each test.

### Example 4

Six grams (6 g) of a 50% stock composition comprising carbohydrate (ASH-100) was diluted with 94 g of tap water for a carbohydrate composition comprising 3.0% carbohydrate. The 3.0% carbohydrate composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

### Example 5

Thirty grams (30 g) of a 10% stock composition comprising CMC-45 was diluted with 70 g of tap water for an aqueous composition comprising 3.0% CMC-45. The 3.0% composition was then applied at a rate of 2 L/m² (8.48 g composition per specimen) as a film application to three specimens in test cups containing sieved, 65 g “−100 mesh” gold ore. The specimens were dried before each of three rain tests of 100 mL tap water through spray fixture for each of the three specimens.

### Example 6

This example provides for dual application of carbohydrate composition and aqueous composition comprising low-DS CMC whereby the compositions were applied separately to the surface of an aggregate substrate. 6 g of a 50% stock composition comprising carbohydrate (ASH-100) was diluted with 94 g of tap water for a carbohydrate composition comprising 3.0% carbohydrate. 30 g of 10% stock composition comprising CMC-45 was diluted with 70 g of tap water to make an aqueous composition comprising 3.0% CMC-45. First, the carbohydrate composition comprising 3.0% ASH-100 carbohydrate was applied at a rate of 1 L/m² (4.24 g composition per specimen) as a film application to three specimens in test cups containing sieved, 65 g “−100 mesh” gold ore. Thereafter, the aqueous composition comprising 3.0% CMC-45 was applied at a rate of film application of 1 L/m² CMC (4.24 g composition per specimen) to each of these specimens as a film application to the three specimens. The specimens were dried before each of three rain tests of 100 mL tap water through spray fixture for each of the three specimens.

### Example 7

This example provides for the application of a mixture of carbohydrate composition and aqueous composition comprising low-DS CMC to the surface of an aggregate substrate. 6 g of a 50% stock composition comprising carbohydrate (ASH-100) was diluted with 94 g of tap water for a carbohydrate composition comprising 3.00% carbohydrate. 30 g of 10% stock composition comprising CMC-45 was diluted with 70 g of tap water to make an aqueous composition comprising 3.0% CMC-45. These carbohydrate and the aqueous compositions were then mixed together at a 1:1 ratio and the mixture was applied at a rate of film application of 2 L/m² (8.48 g total of composition per specimen) to three specimens in test cups containing sieved, 65 g “−100 mesh” gold ore. The specimens were dried before each of three rain tests of 100 mL tap water through spray fixture for each of the three specimens.

### Example 8

This example provides for dual application of carbohydrate composition and aqueous composition comprising low-DS CMC whereby the compositions were applied separately to the surface of an aggregate substrate. 12 g of a 50% stock composition comprising carbohydrate (ASH-100) was diluted with 88 g of tap water for a carbohydrate composition comprising 6.0% carbohydrate. 60 g of 10% stock composition comprising CMC-45 was diluted with 40 g of tap water to make an aqueous composition comprising 6.0% CMC-45. First, the carbohydrate composition comprising 6.0% ASH-100 carbohydrate was applied at a rate of 1 L/m² (4.24 g composition per specimen) as a film application to three specimens in test cups containing sieved, 65 g “−100 mesh” gold ore. Thereafter, the aqueous composition comprising 6.0% CMC-45 was applied at a rate of film application of 1 L/m² CMC (4.24 g composition per specimen) to each of these specimens as a film application to three specimens. The specimens were dried before each of three rain tests of 100 mL tap water through spray fixture for each of the three specimens.

### Example 9

This example provides for the application of a mixture of carbohydrate composition and aqueous composition comprising low-DS CM to the surface of an aggregate substrate. 12 g of a 50% stock composition comprising carbohydrate (ASH-100) was diluted with 88 g of tap water for a carbohydrate composition comprising 6.0% carbohydrate. 60 g of 10/o stock composition comprising CMC-45 was diluted with 40 g of tap water to make an aqueous composition comprising 6.0% CMC-45. These carbohydrate and aqueous compositions were then mixed together at a 1:1 ratio and the mixture was applied at a rate of film application of 2 L/m² (8.48 g total of composition per specimen) to three specimens in test cups containing sieved, 65 g “−100 mesh” gold ore. The specimens were dried before each of three rain tests of 100 mL tap water through spray fixture for each of the three specimens.

In Examples 4-9, low-DS CMC is shown as useful in combination with other soil stabilizers (i.e. carbohydrate) to improve performance. The low-DS CMC can be combined with other soil stabilizers as mixed composition and applied as one application to surfaces of aggregate substrates or the low-DS CMC can be effectively applied separately from the application of other soil stabilizers.

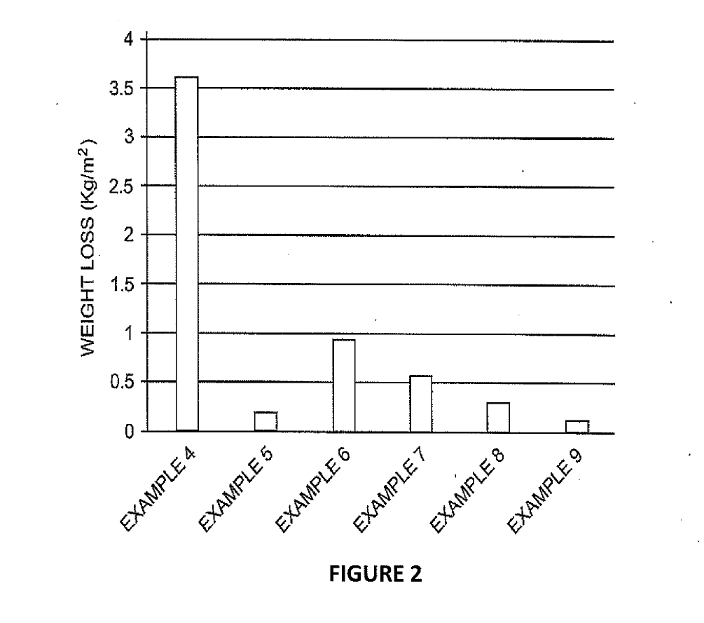

The results as shown in FIG. 2 indicate that the gold ore treated with 3.0% active composition of ASH-100 carbohydrate at 2 L/m² dosage incurred weight loss when the ore was subjected to three consecutive washes with 100 mL water, whereas when the gold ore was treated with 3.0% active CMC-45 at 2 L/m² dosage, the weight loss of the gold ore was significantly reduced compared to the treatment with carbohydrate composition. When the gold ore surface was treated in a dual application with 3.0% carbohydrate composition followed by 3.0% CMC-45 composition (Example 6), the gold ore weight loss was significantly less than the application of ASH-100 alone but higher than the application of 3.0% active CMC-45. This can be explained by the fact that in the 3.0% dual application the dosage of CMC-45 was cut in half (1 L/m² of 3% active CMC-45 was applied in the 3.0% dual application). When treating the gold ore with 6.0% carbohydrate composition followed by 6.0% CMC-45 composition (Example 8) the dosage of CMC-45 was increased to the same dosage level that was used for 3.0% active CMC-45. The performance of 6.0% dual application in Example 8 improved compared to the dual application of Example 6. The same trend was also seen in the 3.0% and 6.0% mixed applications of Examples 7 and 9 that is as the amount of CMC-45 in the aqueous composition increased the weight loss of gold ore decreased.

We claim:

1. A method of stabilizing an aggregate substrate having at least an upper surface comprising the step of applying an aqueous composition comprising carboxymethylcellulose having a degree of substitution of from about 0.33 to about 0.94 to the upper surface.

2. The method of claim 1, wherein the degree of substitution is about 0.40 to about 0.80.

3. The method of claim 1, wherein the aqueous composition comprises up to about 10% of the carboxymethylcellulose.

4. The method of claim 3, wherein the aqueous composition comprises from about 1% to about 7% of the carboxymethylcellulose.

5. The method of claim 1, wherein the aqueous composition further comprises one or more supplemental soil stabilizing compounds.

6. The method of claim 5, wherein the aqueous composition comprises up to about 6% of the supplemental soil stabilizing compounds.

7. The method of claim 6, wherein the aqueous composition comprises about 1% to about 5% of the supplemental soil stabilizing compounds.

8. The method of claim 5, wherein the supplemental soil stabilizing compound is selected from the group consisting of carbohydrate, hydrolyzed starch, hydrolyzed carbohydrate, crude tall oil, fatty acid, esters of fatty acid, rosin, rosin acid, esters of rosin acid, lignosulfonate, magnesium halide, calcium halide, ammonium sulfate, synthetic polymer, latex based product, latex waste product and combinations thereof.

9. The method of claim 8, wherein the synthetic polymer is selected from the group consisting of polyacrylamide, polyacrylate, polyvinyl alcohol and polyethylene oxide.

10. The method of claim 1, comprising the additional step of applying a composition comprising one or more supplemental soil stabilizing compounds and water to the upper surface.

11. The method of claim 5, wherein the wherein the supplemental soil stabilizing compound is selected from the group consisting of carbohydrate, hydrolyzed starch, hydrolyzed carbohydrate, crude tall oil, fatty acid, esters of fatty acid, rosin, rosin acid, esters of rosin acid, lignosulfonate, magnesium halide, calcium halide, ammonium sulfate, synthetic polymer, latex based product, latex waste product and combinations thereof.

12. The method of claim 8, wherein the synthetic polymer is selected from the group consisting of polyacrylamide, polyacrylate, polyvinyl alcohol and polyethylene oxide.

13. The method of claim 5, wherein composition comprising one or more supplemental soil stabilizing compounds has up to about 6% of the supplemental soil stabilizing compounds.

14. The method of claim 13, wherein the composition comprising one or more supplemental soil stabilizing compounds has about 1% to about 5% of the supplemental soil stabilizing compounds.

15. The method of claim 1, wherein the aqueous composition further comprises a biocide.

16. The method of claim 1, wherein the aggregate substrate comprises inorganic particulate material, organic particulate material or combinations thereof.

17. The method of claim 1, wherein a dried residue of the aqueous composition suppresses removal of the particulate material from the upper surface.

18. The method of claim 1, wherein a dried residue of the aqueous composition prevents erosion of the particulate material from the aggregate substrate.

19. The method of claim 1, wherein a dried residue of the aqueous composition repels water from permeating through the upper surface.

20. The method of claim 1, comprising the additional step of providing a means for applying the aqueous composition by spraying the aqueous composition on the upper surface.
